(19) United States
(12) Patent Application Publication
(10) Pub. No.: US 2019/0297004 A1
(43) Pub. Date: Sep. 26, 2019

(54) BAYESIAN DYNAMIC MULTIHOP WIRELESS BEST PATH PREDICTION

(71) Applicant: Cisco Technology, Inc., San Jose, CA (US)

(72) Inventors: Enzo Fenoglio, Issy-Les-Moulineaux (FR); Hugo Latapie, Long Beach, CA (US); Pascal Thubert, La Colle Sur Loup (FR)

(21) Appl. No.: 15/927,014

(22) Filed: Mar. 20, 2018

(51) Int. Cl. H04L 12/721; H04W 40/16; H04W 40/18; H04W 40/10; G06N 7/00; G06F 15/18

(52) U.S. Cl. CPC H04L 45/123; H04W 40/16; H04W 40/18; G06F 15/18; H04L 45/124; G06N 7/005; H04W 40/10

(57) ABSTRACT

In one embodiment, a processor receives observed node characteristics of a node in a network. The node characteristics include a link cost metric for a network link associated with the node. The processor uses a Bayesian learning model to estimate a virtual link cost metric based on the observed node characteristics. The model uses statistics regarding the observed link cost metric as background belief measures. The processor forms a routing path in the network that includes the network link in part based on an objective function that uses the virtual link cost metric as a parameter.

### TECHNICAL FIELD

The present disclosure relates generally to computer networks, and, more particularly, to dynamically predicting the best multihop path in a wireless network using Bayesian analysis.

### BACKGROUND

Low power and Lossy Networks (LLNs), e.g., sensor networks, have a myriad of applications, such as Smart Grid and Smart Cities. Various challenges are presented with LLNs, such as lossy links, low bandwidth, battery operation, low memory and/or processing capability of a device, etc. Changing environmental conditions may also affect device communications. For example, physical obstructions (e.g., changes in the foliage density of nearby trees, the opening and closing of doors, etc.), changes in interference (e.g., from other wireless networks or devices), propagation characteristics of the media (e.g., temperature or humidity changes, etc.), and the like, also present unique challenges to LLNs.

In contrast to many traditional computer networks, LLN devices typically communicate via shared-media links. For example, LLN devices that communicate wirelessly may communicate using overlapping wireless channels (e.g., frequencies). In other cases, LLN devices may communicate with one another using shared power line communication (PLC) links. For example, in a Smart Grid deployment, an electric utility may distribute power to various physical locations. At each location may be a smart meter that communicates wirelessly and/or using the electrical power distribution line itself as a communication medium.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example network device/node;

FIG. 3 illustrates an example routing protocol message format;

FIG. 4 illustrates an example directed acyclic graph (DAG) in the network;

FIG. 5 illustrates an example of a Bayesian approach to estimating a virtual expected transmission count (ETX) metric; and

FIG. 6 illustrates an example simplified procedure for deriving a virtual path cost metric using a Bayesian learning model.

### DESCRIPTION OF EXAMPLE EMBODIMENTS

### Overview

According to one or more embodiments of the disclosure, a processor receives observed node characteristics of a node in a network. The node characteristics include a link cost metric for a network link associated with the node. The processor uses a Bayesian learning model to estimate a virtual link cost metric based on the observed node characteristics. The model uses statistics regarding the observed link cost metric as background belief measures. The processor forms a routing path in the network that includes the network link in part based on an objective function that uses the virtual link cost metric as a parameter.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC) such as IEEE 61334, IEEE 1901.2, and others. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

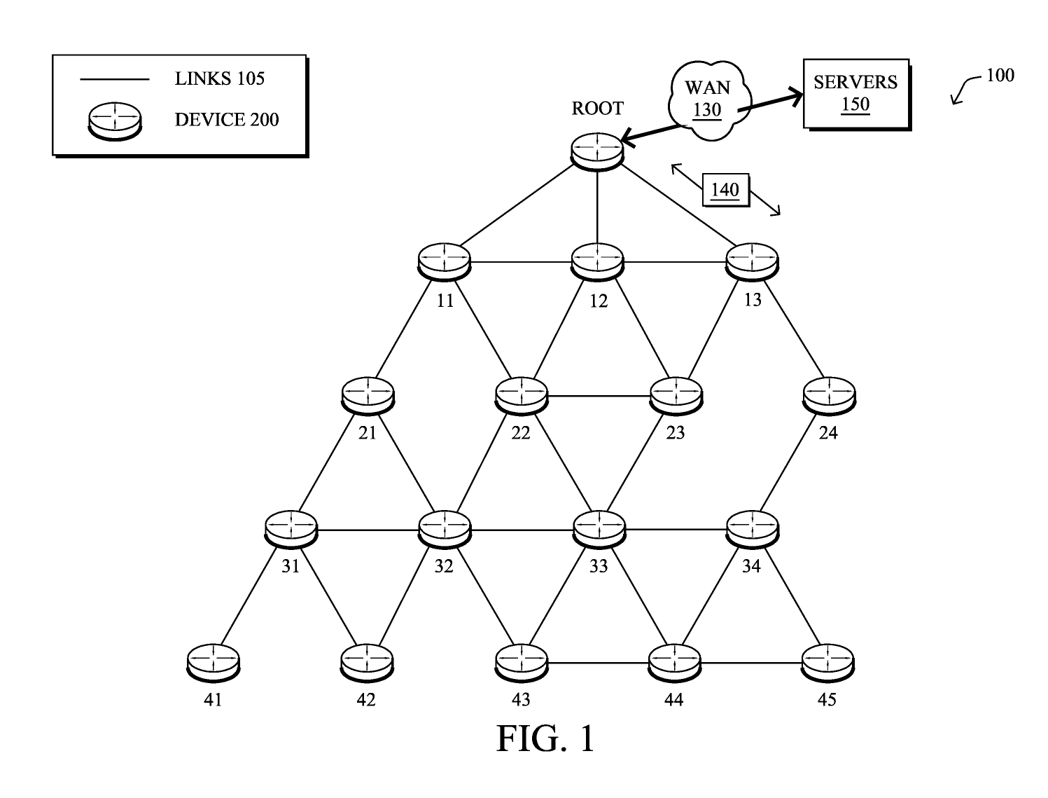

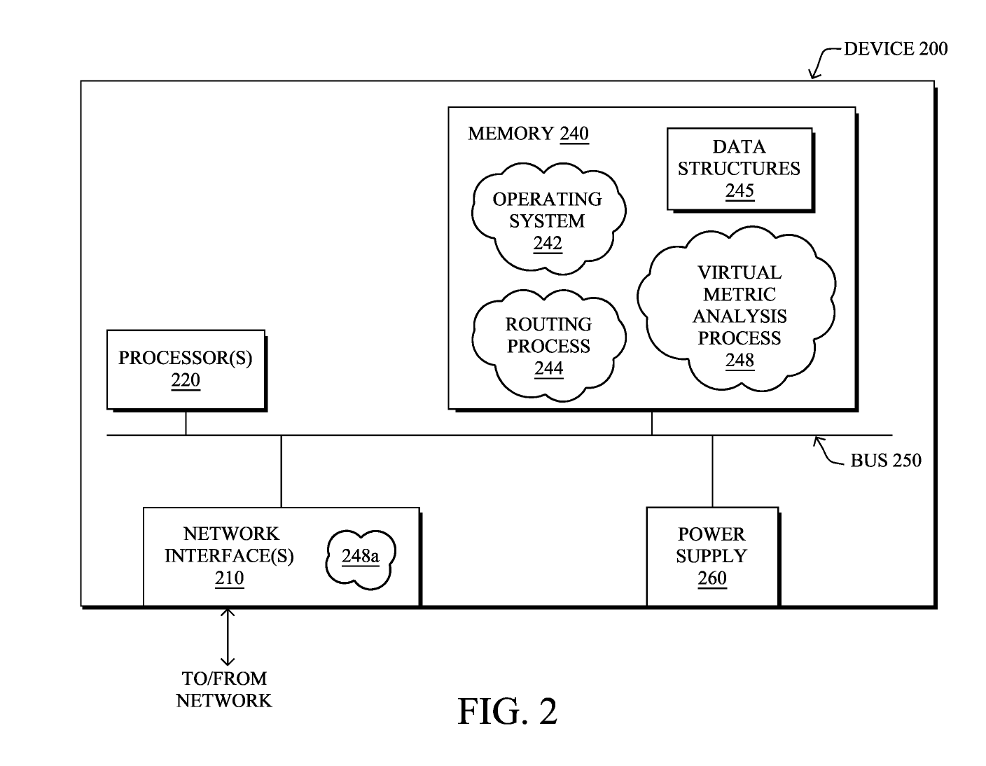

FIG. 1 is a schematic block diagram of an example computer network 100 illustratively comprising nodes/devices 110 (e.g., labeled as shown, “root,” “11,” “12,” . . . “45,” and described in FIG. 2 below) interconnected by various methods of communication. For instance, the links 105 may be wired links or shared media (e.g., wireless links, PLC links, etc.) where certain nodes 110, such as, e.g., routers, sensors, computers, etc., may be in communication with other nodes 110, e.g., based on distance, signal strength, current operational status, location, etc. The illustrative root node, such as a field area router (FAR) of a FAN, may interconnect the local network with a WAN 130, which may house one or more other relevant devices such as management devices or servers 150, e.g., a network management server (NMS), a dynamic host configuration protocol (DHCP) server, a constrained application protocol (CoAP) server, etc. Those skilled in the art will understand that any number of nodes, devices, links, etc. may be used in the computer network, and that the view shown herein is for simplicity. Also, those skilled in the art will further understand that while the network is shown in a certain orientation, particularly with a “root” node, the network 100 is merely an example illustration that is not meant to limit the disclosure.

Data packets 140 (e.g., traffic and/or messages) may be exchanged among the nodes/devices of the computer network 100 using predefined network communication protocols such as certain known wired protocols, wireless protocols (e.g., IEEE Std. 802.15.4, WiFi, Bluetooth®, etc.), PLC protocols, or other shared-media protocols where appropriate. In this context, a protocol consists of a set of rules defining how the nodes interact with each other.

FIG. 2 is a schematic block diagram of an example node/device 200 that may be used with one or more embodiments described herein, e.g., as any of the nodes shown in FIG. 1 above. The device may comprise one or more network interfaces 210 (e.g., wired, wireless, PLC, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links 105 coupled to the network 100. The network interfaces may be configured to transmit and/or receive data using a variety of different communication protocols. Note, further, that the nodes may have two different types of network connections 210, e.g., wireless and wired/physical connections, and that the view herein is merely for illustration. Also, while the network interface 210 is shown separately from power supply 260, for PLC (where the PLC signal may be coupled to the power line feeding into the power supply) the network interface 210 may communicate through the power supply 260, or may be an integral component of the power supply.

The memory 240 comprises a plurality of storage locations that are addressable by the processor 220 and the network interfaces 210 for storing software programs and data structures associated with the embodiments described herein. Note that certain devices may have limited memory or no memory (e.g., no memory for storage other than for programs/processes operating on the device and associated caches). The processor 220 may comprise hardware elements or hardware logic adapted to execute the software programs and manipulate the data structures 245. An operating system 242, portions of which are typically resident in memory 240 and executed by the processor, functionally organizes the device by, inter alia, invoking operations in support of software processes and/or services executing on the device. These software processes and/or services may comprise a routing process/services 244 and an illustrative “virtual metric analysis” process 248, which may be configured depending upon the particular node/device within the network 100 with functionality ranging from intelligent learning machine processes to merely communicating with intelligent learning machines, as described herein. Note also that while the virtual metric analysis process 248 is shown in centralized memory 240, alternative embodiments provide for the process to be specifically operated within the network interfaces 210 (e.g., “248a”).

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Routing process (services) 244 contains computer executable instructions executed by the processor 220 to perform functions provided by one or more routing protocols, such as proactive or reactive routing protocols as will be understood by those skilled in the art. These functions may, on capable devices, be configured to manage a routing/forwarding table (a data structure 245) containing, e.g., data used to make routing/forwarding decisions. In particular, in proactive routing, connectivity is discovered and known prior to computing routes to any destination in the network, e.g., link state routing such as Open Shortest Path First (OSPF), or Intermediate-System-to-Intermediate-System (ISIS), or Optimized Link State Routing (OLSR). Reactive routing, on the other hand, discovers neighbors (i.e., does not have an a priori knowledge of network topology), and in response to a needed route to a destination, sends a route request into the network to determine which neighboring node may be used to reach the desired destination. Example reactive routing protocols may comprise Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

Low power and Lossy Networks (LLNs), e.g., certain sensor networks, may be used in a myriad of applications such as for “Smart Grid” and “Smart Cities.” A number of challenges in LLNs have been presented, such as:

1) Links are generally lossy, such that a Packet Delivery Rate/Ratio (PDR) can dramatically vary due to various sources of interferences, e.g., considerably affecting the bit error rate (BER);

2) Links are generally low bandwidth, such that control plane traffic must generally be bounded and negligible compared to the low rate data traffic;

3) There are a number of use cases that require specifying a set of link and node metrics, some of them being dynamic, thus requiring specific smoothing functions to avoid routing instability, considerably draining bandwidth and energy;

4) Constraint-routing may be required by some applications, e.g., to establish routing paths that will avoid non-encrypted links, nodes running low on energy, etc.;

5) Scale of the networks may become very large, e.g., on the order of several thousands to millions of nodes; and

6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid, smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

An example protocol specified in an Internet Engineering Task Force (IETF) Proposed Standard, Request for Comment (RFC) 6550, entitled “RPL: IPv6 Routing Protocol for Low Power and Lossy Networks” by Winter, et al. (March 2012), provides a mechanism that supports multipoint-to-point (MP2P) traffic from devices inside the LLN towards a central control point (e.g., LLN Border Routers (LBRs) or “root nodes/devices” generally), as well as point-to-multipoint (P2MP) traffic from the central control point to the devices inside the LLN (and also point-to-point, or “P2P” traffic). RPL (pronounced “ripple”) may generally be described as a distance vector routing protocol that builds a Directed Acyclic Graph (DAG) for use in routing traffic/packets 140, in addition to defining a set of features to bound the control traffic, support repair, etc. Notably, as may be appreciated by those skilled in the art, RPL also supports the concept of Multi-Topology-Routing (MTR), whereby multiple DAGs can be built to carry traffic according to individual requirements.

A DAG is a directed graph having the property that all edges (and/or vertices) are oriented in such a way that no cycles (loops) are supposed to exist. All edges are contained in paths oriented toward and terminating at one or more root nodes (e.g., “clusterheads or “sinks”), often to interconnect the devices of the DAG with a larger infrastructure, such as the Internet, a wide area network, or other domain. In addition, a Destination Oriented DAG (DODAG) is a DAG rooted at a single destination, i.e., at a single DAG root with no outgoing edges. A “parent” of a particular node within a DAG is an immediate successor of the particular node on a path towards the DAG root, such that the parent has a lower “rank” than the particular node itself, where the rank of a node identifies the node's position with respect to a DAG root (e.g., the farther away a node is from a root, the higher is the rank of that node). Further, in certain embodiments, a sibling of a node within a DAG may be defined as any neighboring node which is located at the same rank within a DAG. Note that siblings do not necessarily share a common parent, and routes between siblings are generally not part of a DAG since there is no forward progress (their rank is the same). Note also that a tree is a kind of DAG, where each device/node in the DAG generally has one parent or one preferred parent.

DAGs may generally be built (e.g., by a DAG process) based on an Objective Function (OF). The role of the Objective Function is generally to specify rules on how to build the DAG (e.g. number of parents, backup parents, etc.).

In addition, one or more metrics/constraints may be advertised by the routing protocol to optimize the DAG against. Also, the routing protocol allows for including an optional set of constraints to compute a constrained path, such as if a link or a node does not satisfy a required constraint, it is “pruned” from the candidate list when computing the best path. (Alternatively, the constraints and metrics may be separated from the OF.) Additionally, the routing protocol may include a “goal” that defines a host or set of hosts, such as a host serving as a data collection point, or a gateway providing connectivity to an external infrastructure, where a DAG's primary objective is to have the devices within the DAG be able to reach the goal. In the case where a node is unable to comply with an objective function or does not understand or support the advertised metric, it may be configured to join a DAG as a leaf node. As used herein, the various metrics, constraints, policies, etc., are considered “DAG parameters.”

Illustratively, example metrics used to select paths (e.g., preferred parents) may comprise cost, delay, latency, bandwidth, expected transmission count (ETX), etc., while example constraints that may be placed on the route selection may comprise various reliability thresholds, restrictions on battery operation, multipath diversity, bandwidth requirements, transmission types (e.g., wired, wireless, etc.). The OF may provide rules defining the load balancing requirements, such as a number of selected parents (e.g., single parent trees or multi-parent DAGs). Notably, an example for how routing metrics and constraints may be obtained may be found in an IETF RFC, entitled “Routing Metrics used for Path Calculation in Low Power and Lossy Networks”<RFC 6551> by Vasseur, et al. (March 2012 version). Further, an example OF (e.g., a default OF) may be found in an IETF RFC, entitled “RPL Objective Function 0”<RFC 6552> by Thubert (March 2012 version) and “The Minimum Rank Objective Function with Hysteresis” <RFC 6719> by O. Gnawali et al. (September 2012 version).

Building a DAG may utilize a discovery mechanism to build a logical representation of the network, and route dissemination to establish state within the network so that routers know how to forward packets toward their ultimate destination. Note that a “router” refers to a device that can forward as well as generate traffic, while a “host” refers to a device that can generate but does not forward traffic. Also, a “leaf” may be used to generally describe a non-router that is connected to a DAG by one or more routers, but cannot itself forward traffic received on the DAG to another router on the DAG. Control messages may be transmitted among the devices within the network for discovery and route dissemination when building a DAG.

According to the illustrative RPL protocol, a DODAG Information Object (DIO) a type of DAG discovery message that carries information that allows a node to discover a RPL Instance, learn its configuration parameters, select a DODAG parent set, and maintain the upward routing topology. In addition, a Destination Advertisement Object (DAO) is a type of DAG discovery reply message that conveys destination information upwards along the DODAG so that a DODAG root (and other intermediate nodes) can provision downward routes. A DAO message includes prefix information to identify destinations, a capability to record routes in support of source routing, and information to determine the freshness of a particular advertisement. Notably, “upward” or “up” paths are routes that lead in the direction from leaf nodes towards DAG roots, e.g., following the orientation of the edges within the DAG. Conversely, “downward” or “down” paths are routes that lead in the direction from DAG roots towards leaf nodes, e.g., generally going in the opposite direction to the upward messages within the DAG.

Generally, a DAG discovery request (e.g., DIO) message is transmitted from the root device(s) of the DAG downward toward the leaves, informing each successive receiving device how to reach the root device (that is, from where the request is received is generally the direction of the root). Accordingly, a DAG is created in the upward direction toward the root device. The DAG discovery reply (e.g., DAO) may then be returned from the leaves to the root device(s) (unless unnecessary, such as for UP flows only), informing each successive receiving device in the other direction how to reach the leaves for downward routes. Nodes that are capable of maintaining routing state may aggregate routes from DAO messages that they receive before transmitting a DAO message. Nodes that are not capable of maintaining routing state, however, may attach a next-hop parent address. The DAO message is then sent directly to the DODAG root that can in turn build the topology and locally compute downward routes to all nodes in the DODAG. Such nodes are then reachable using source routing techniques over regions of the DAG that are incapable of storing downward routing state. In addition, RPL also specifies a message called the DIS (DODAG Information Solicitation) message that is sent under specific circumstances so as to discover DAG neighbors and join a DAG or restore connectivity.

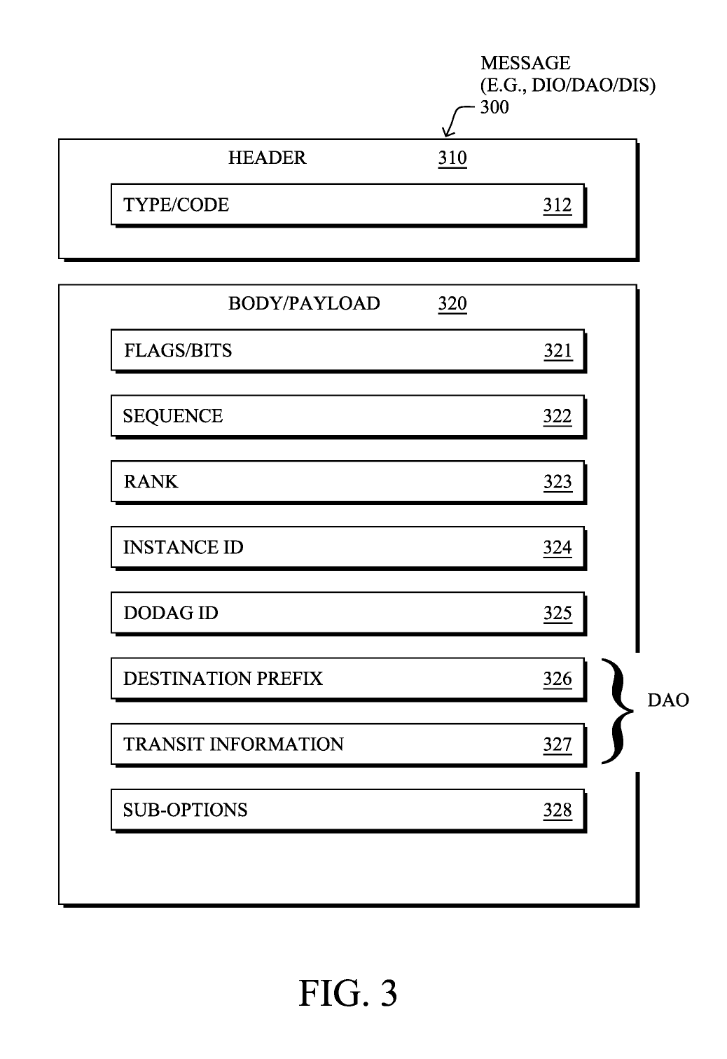

FIG. 3 illustrates an example simplified control message format 300 that may be used for discovery and route dissemination when building a DAG, e.g., as a DIO, DAO, or DIS message. Message 300 illustratively comprises a header 310 with one or more fields 312 that identify the type of message (e.g., a RPL control message), and a specific code indicating the specific type of message, e.g., a DIO, DAO, or DIS. Within the body/payload 320 of the message may be a plurality of fields used to relay the pertinent information. In particular, the fields may comprise various flags/bits 321, a sequence number 322, a rank value 323, an instance ID 324, a DODAG ID 325, and other fields, each as may be appreciated in more detail by those skilled in the art. Further, for DAO messages, additional fields for destination prefixes 326 and a transit information field 327 may also be included, among others (e.g., DAO Sequence used for ACKs, etc.). For any type of message 300, one or more additional sub-option fields 328 may be used to supply additional or custom information within the message 300. For instance, an objective code point (OCP) sub-option field may be used within a DIO to carry codes specifying a particular objective function (OF) to be used for building the associated DAG. Alternatively, sub-option fields 328 may be used to carry other certain information within a message 300, such as indications, requests, capabilities, lists, notifications, etc., as may be described herein, e.g., in one or more type-length-value (TLV) fields.

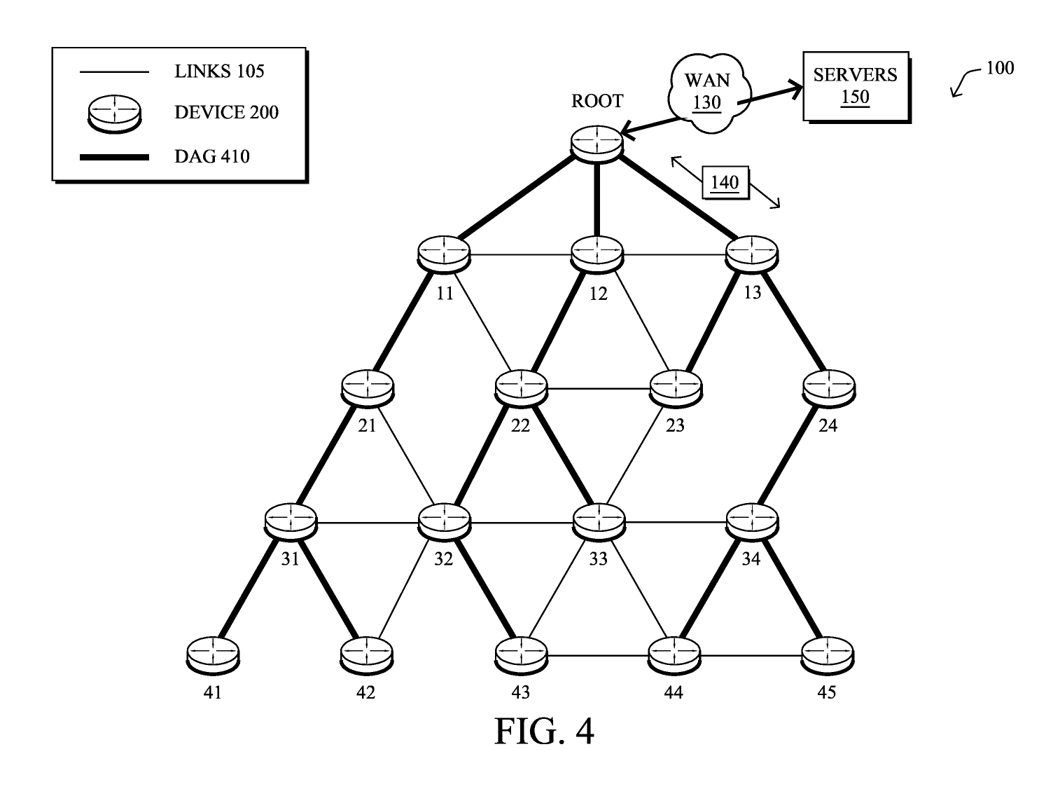

FIG. 4 illustrates an example simplified DAG that may be created, e.g., through the techniques described above, within network 100 of FIG. 1. For instance, certain links 105 may be selected for each node to communicate with a particular parent (and thus, in the reverse, to communicate with a child, if one exists). These selected links form the DAG 410 (shown as bolded lines), which extends from the root node toward one or more leaf nodes (nodes without children). Traffic/packets 140 (shown in FIG. 1) may then traverse the DAG 410 in either the upward direction toward the root or downward toward the leaf nodes, particularly as described herein.

As noted above, wireless sensor networks, such as smart grid Advanced Metering Infrastructure (AMI) networks, may form a mesh of nodes. In some applications, a sub-network may be formed between a FAR and any number of wireless nodes, each node having potentially hundreds of other nodes within its transmission range. Forming such a wireless mesh is a complex and highly competitive task. Indeed, the proper selection of a suitable route is one of the most significant tasks for improving the performance of the mesh in terms of throughput, latency, data integrity, and energy efficiency, typically also in the presence of dynamically changing, unreliable, and asymmetric wireless channels. This path selection typically involves two steps: 1.) making a long-term routing decision that builds a stable graph (e.g., an RPL DODAG) and 2.) making a per-packet forwarding decision that selects which of the feasible successors in the graph is to be used for a given packet.

The quality of the chosen routing path depends on the selected cost metric that represents the “cost” of a link between nodes. In multi-hop wireless networks, while transmitting data packets from source node to destination sink through intermediate nodes, there exist a number of communication paths through which data can be forwarded at a higher throughput, despite some packet losses. The routing metric that predicts the number of retransmissions required using per-link measurements of packet loss ratios in both directions of each wireless link is typically the expected transmission count (ETX).

RFC 6719 mentioned previously recommends using ETX as the cost metric to form the wireless mesh. However, ETX is only an indirect approximation of an ideal cost that would build the best possible mesh. More specifically, ETX is based on recent packet delivery statistics.

Other, widely different forms of information that are related to that ideal cost include Receive Signal Strength (RSSI) metrics and other proprietary Link Quality Indicator (LQI) estimations. To obtain these measurements, actual network transmissions are needed. Yet, other approaches to the objective cost function involve measuring the energy in the air, prior-knowledge of the physical location of potential interferers, and the like. As it goes, RSSI is affected by the environment, since reflections interfere with the signal, either to augment the signal or reduce it. LQI is vendor specific. In addition, energy in the air at the sender does not always represent an issue at the receiver. The physical location impacts the quality of the link but then again it is an indirect approximation. All in all, these other metrics are related, but in different ways and with different factors. Ultimately, none of these metrics, including ETX metrics, are ideal.

Bayesian Dynamic Multihop Wireless Best Path Prediction

The techniques herein introduce a new link cost metric that is “virtual” in the sense that it cannot be directly measured or observed from the wireless network itself. In some aspects, the techniques herein use a Bayesian approximate inferential model to estimate short-term channel variations generated by the hidden, “virtual” metric by taking into account short-term channel variations and long-term/average node characteristics that can be directly observed/derived from the network.

Specifically, according to one or more embodiments of the disclosure as described in detail below, a processor receives observed node characteristics of a node in a network. The node characteristics include a link cost metric for a network link associated with the node. The processor uses a Bayesian learning model to estimate a virtual link cost metric based on the observed node characteristics. The model uses statistics regarding the observed link cost metric as background belief measures. The processor forms a routing path in the network that includes the network link in part based on an objective function that uses the virtual link cost metric as a parameter.

Illustratively, the techniques described herein may be performed by hardware, software, and/or firmware, such as in accordance with the virtual metric analysis process 248, which may include computer executable instructions executed by the processor 220 (or independent processor of interfaces 210) to perform functions relating to the techniques described herein, e.g., in conjunction with routing process 244.

Operationally, the techniques herein consolidate correlated, noisy, and incomplete information to derive a virtual metric that can be used as an objective/cost function parameter for purposes of path selection in a network. Traditionally, wireless mesh networks are focused on finding paths with a minimum hop count, with the main goal of achieving the best quality and efficiency possible for data transmissions between source and destination nodes. While ETX improves network throughput when compared to the hop count metric, it does not track variations on the channel at short time scale due to potential route instability, which can be observable in other measurements, such as LQI. ETX also does not estimate the link budget over the radio channel like RSSI does.

According to various embodiments, the techniques herein instead propose using a Bayesian approximate inferential model to estimate short-term channel variations generated by the hidden “virtual metric,” taking into account short-term channel variations and long-term (average) routing metrics variables that can be measured directly from the network, but may be noisy and/or have incomplete or partial information. For example, the metrics may include observed node characteristics such as, but not limited to, ETX, RSSI, LQI, channel noise level, carrier-sense multiple access (CSMA) statistics such as time spent in transmit queues, etc.

Said differently, the techniques herein establish a new, ideal link/path cost measure that can be used to construct an optimal routing topology for the network (e.g., an optimal RPL DODAG, etc.), but cannot be measured directly by a physical sensor. Instead, the virtual metric is hidden behind the observable metrics and can only be inferred from the observable metrics. Accordingly, the techniques herein introduce a mathematical model/construct from which the virtual metric can be extracted from the statistical properties of the model/construct. More specifically, the techniques herein can be used to reconstruct, and more importantly, to predict, the virtual metric, so that a better mesh can be formed at routing time. In turn, at forwarding time, a packet can be passed to the best next hop according to the virtual cost metric.

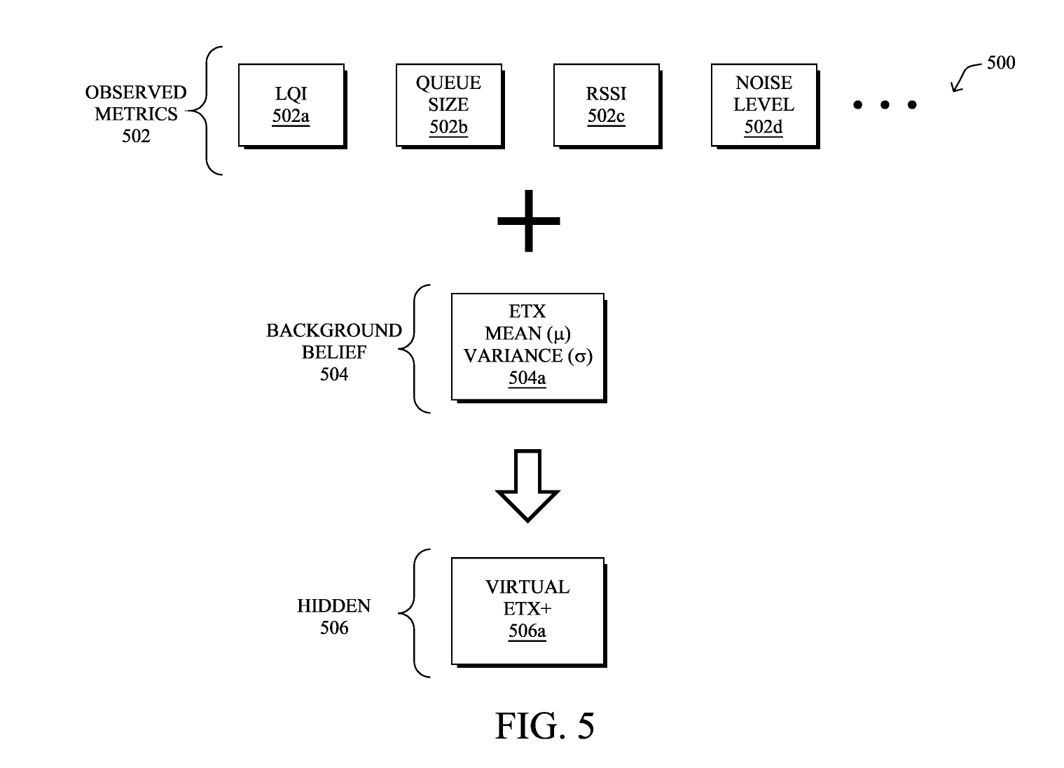

FIG. 5 illustrates an example 500 of a Bayesian approach to estimating a virtual expected transmission count (ETX) metric, in various embodiments. This approach may be implemented, for example, by virtual metric analysis process 248 described previously. As shown, there may be any number of observed, and observable, short-term metrics 502 available from the network (e.g., a first through n^{th} observed metric 502). For example, these metrics 502 may include, but are not limited to, an LQI metric 502a, a queue size metric 502b, an RSSI metric 502c, a channel noise level metric 502d, and/or any other measurable characteristic of a node. Other observable node characteristics may include round trip time (RTT) metrics, the remaining energy or charge of the node, the energy consumption rate of the node, or the like.

According to various embodiments, virtual metric analysis process 248 may use a Bayesian learning technique to infer the true (hidden) cost metric based in part on the observed metrics 502 that are actually available from the network. If they are correlated, they will contribute to build the overall statistical distribution used by the model. Conversely, if they are not correlated, they will not contribute as the statistical representation of the hidden variable is built (using a distribution of probability).

Any number of Bayesian machine learning approaches can be used, such as, but not limited to, expectation propagation, mean-field-methods, belief propagation, and the like. Of course, in other embodiments, a heuristic-based model could also be used to estimate the virtual cost metric. However, heuristic approaches drive biases and are difficult to apply, in the general case. Instead, Bayesian machine learning can be used to construct a probabilistic model that captures the dependencies among all observed and unobserved variables, whereby learning is used for computing the posterior distribution over unobserved variables including both latent variables and model parameters given the observed data. Such Bayesian learning will be able to discover those metrics which are meaningful for the particular setup (e.g., application, hardware, topology, etc.).

In general, Bayesian machine learning entails building a probabilistic model that captures the dependencies among all observed and unobserved variables, and whereby machine learning is used for computing the posterior distribution over unobserved variables including both latent variables and model parameters given the observed data. This can be applied to compute the statistics of hidden variables x=(x₁, x₂, . . . , xₙ), which represents a hidden best metric, given the observed data y=(y₁, y₂, . . . , yₙ), which represents the multimodal set of observed signals and a generative model relating x to y, specified by the joint distribution p(x, y). For this purpose, the techniques herein use the posterior distribution p(x|y). Determining the maximum value of the posterior distribution gives the most probable assignment of x for an instance of y. However, direct computation is intractable and is typically done by variational approximations consisting in replacing p(x|y) by a tractable family of distributions q(x) and minimizing any desired measure between p(x|y)] and q(x). For example, the Kullback-Leibler divergence KL[q(x)∥p(x|y)] can be used, subjected to the constrain that the first two moments (mean and variance) of p(x) are known.

On a regular basis (e.g., at scheduled times, periodically, on demand, etc.), a measurement may be performed on each network node of interest, to retrieve its observed metrics 502. These measurements may then be used to evaluate the posterior p(x|y) for the purpose of making predictions to find a better metric using the conditional expectation determined by a reference probability measure representing the background subjective degrees of belief of a Bayesian Agent performing the inference. In turn, the system may derive a hidden/virtual cost metric 506 that can be used to make forwarding decisions, either on a per-packet basis or on a per-multiple packet basis.

In some embodiments, the hidden/virtual cost metric 506 inferred by the Bayesian learning model may be designated by “ETX+” metric that is based on an observed long-term ETX metric 504a, but re-tuned from the other observed metrics 502 (e.g., LQI 502a, RSSI metric 502c, etc.), to remove noise. In more detail, Bayesian machine learning (e.g., expectation propagation, mean field methods, belief propagation, etc.) captures the dependencies among all observed variables and unobserved (hidden) variables 506. The hidden/virtual ETX metric 506a may be ETX-based because the first two moments of the inferred metric must be equal to the mean and variance (long-term variables) of the actual observed ETX 504a in the assigned sliding window. More specifically, the mean (μ) and the variance (σ) of the observed ETX 504a are conditional expectations interpreted as representing the background subjective degrees of belief 504 of the Bayesian learning model which infers a short-term optimization ETX+metric 506a, where the inference is conditionalizing the probability measure representing the evidence using the conditional expectations determined by a reference probability measure of the hidden/virtual metric estimations 506. Actually, the estimation of the virtual metric cannot be worse than the observed ETX with the conditional expectations 504a used to bootstrap the inference, on average, i.e., the long-term ETX+ estimation is equivalent to the observed ETX metric. However, other choices can be made for the average values to be used for bootstrapping the virtual metric, in other embodiments. The inferred ETX+ metric 506a is ETX-based but more flexible than the modified ETX (mETX) introduced to overcome the limitations of ETX for channel variability, as the virtual EXT+ metric 506a depends on the dynamics of local short-term metrics 502.

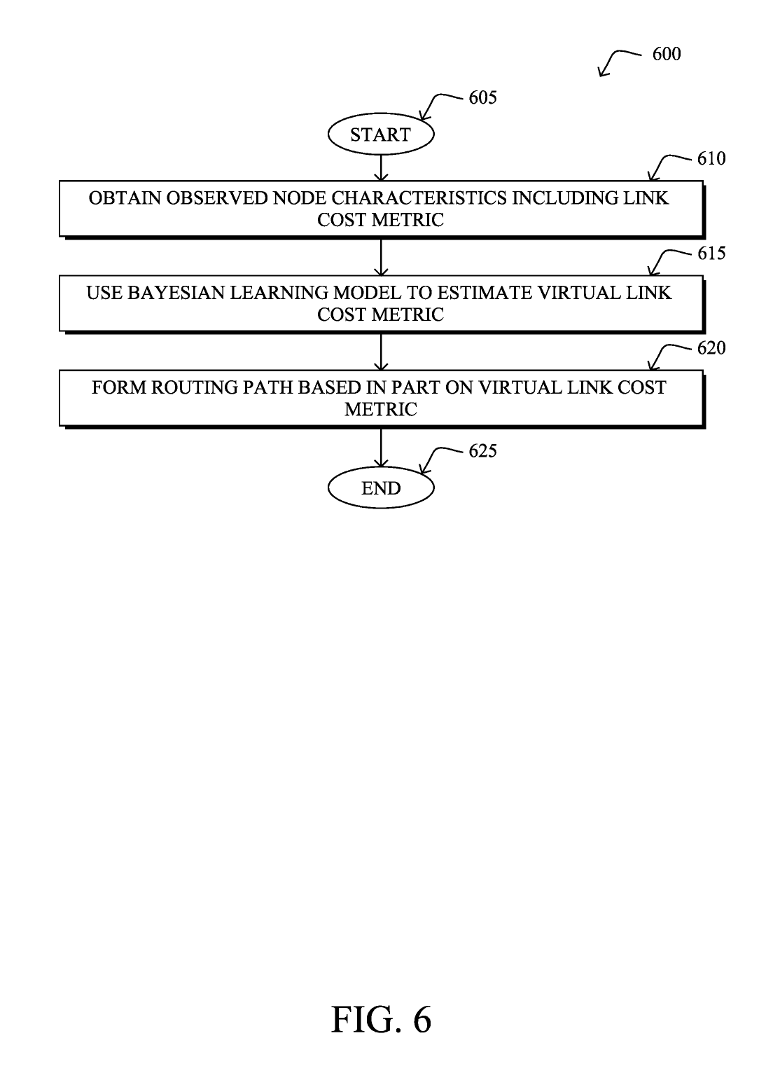

FIG. 6 illustrates an example simplified procedure for deriving a virtual path cost metric using a Bayesian learning model in a network, in accordance with one or more embodiments described herein. For example, a processor of a non-generic, specifically configured device (e.g., device 200) may perform procedure 600 by executing stored instructions (e.g., process 248). The procedure 600 may start at step 605, and continues to step 610, where, as described in greater detail above, the processor may receive observed node characteristics of a node in a network, wherein the node characteristics include a link cost metric for a network link associated with the node. In some embodiments, the link cost metric may be an ETX metric observed for the link. The other node characteristics may include, but are not limited to, an LQI metric, a queue metric, an RSSI metric, a channel noise level metric, a transmission energy measurement for the node, an energy consumption rate for the node, or a remaining energy measurement for the node, combinations thereof, or the like.

At step 615, as detailed above, the processor may use a Bayesian learning model to estimate a virtual link cost metric based on the observed node characteristics. In various embodiments, the model may use statistics to infer a new metric from another (evidence) based on a long-term background measures via conditionalization determined by the background measures. For example, the model may use the mean and variance of an observed ETX for the link as conditional expectations, to compute a “virtual” cost metric that is based on the observed node characteristics. As would be appreciated, such a cost metric may take into account the correlation of the different observed characteristics (e.g., metrics) and may be “virtual” in that it cannot be observed directly from the network.

At step 620, the processor may form a routing path in the network that includes the network link, as described in greater detail above. In various embodiments, this path formation may be based in part on an objective function that uses the virtual link cost metric as a parameter. For example, the processor may determine that a particular packet, or a group of packets, should be forwarded via the link, if the virtual cost metric associated with the link is better than that of any other links of the node, according to the objective function. Procedure 600 then ends at step 625.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, allow for the determination and use of a “virtual” cost metric, for purposes of making routing decisions in a network. Such a metric may provide better performance than that of traditional cost metrics (e.g., ETX, etc.).

While there have been shown and described illustrative embodiments that provide for using Bayesian learning modeling to select a network path, it is to be understood that various other adaptations and modifications may be made within the spirit and scope of the embodiments herein. For example, while certain embodiments are described herein with respect to using certain models for purposes of computing a virtual/hidden cost metric, the models are not limited as such and may be used for other functions, in other embodiments. In addition, while certain protocols are shown, such as RPL, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
receiving, at a processor, observed node characteristics of a node in a network, wherein the node characteristics include a link cost metric for a network link associated with the node;
using, by the processor, a Bayesian learning model to estimate a virtual link cost metric based on the observed node characteristics, wherein the model uses statistics regarding the observed link cost metric as background belief measures; and
forming, by the processor, a routing path in the network that includes the network link in part based on an objective function that uses the virtual link cost metric as a parameter.

2. The method as in claim 1, wherein the observed node characteristics comprise one or more of: a link quality indicator (LQI) for the network link, a received signal strength indicator (RSSI) for the network link, a channel noise level, or a queue metric for the node.

3. The method as in claim 1, wherein forming the routing path in the network that includes the network link comprises:
selecting, by the processor, the link based on the objective function; and
sending, by the processor, a Routing Protocol for Low-Power and Lossy Networks (RPL) message indicative of the selection.

4. The method as in claim 1, wherein the observed link cost metric comprises an expected transmission count (ETX) for the link.

5. The method as in claim 4, wherein the statistics regarding the observed link cost metric used as background belief measures by the Bayesian learning model comprise a mean and variance of the observed ETX for the link as conditional expectations.

6. The method as in claim 1, wherein the observed node characteristics comprise at least one of: a transmission energy measurement for the node, an energy consumption rate for the node, or a remaining energy measurement for the node.

7. The method as in claim 1, wherein the virtual link cost metric is not directly observable in the network.

8. An apparatus, comprising:
one or more network interfaces to communicate with a network;
a processor coupled to the network interfaces and configured to execute one or more processes; and
a memory configured to store a process executable by the processor, the process when executed configured to:
receive observed node characteristics of a node in a network, wherein the node characteristics include a link cost metric for a network link associated with the node;
use a Bayesian learning model to estimate a virtual link cost metric based on the observed node characteristics, wherein the model uses statistics regarding the observed link cost metric as background belief measures; and
form a routing path in the network that includes the network link in part based on an objective function that uses the virtual link cost metric as a parameter.

9. The apparatus as in claim 8, wherein the observed node characteristics comprise one or more of: a link quality indicator (LQI) for the network link, a received signal strength indicator (RSSI) for the network link, a channel noise level, or a queue metric for the node.

10. The apparatus as in claim 8, wherein the apparatus forms the routing path in the network that includes the network link by:
selecting the link based on the objective function; and
sending a Routing Protocol for Low-Power and Lossy Networks (RPL) message indicative of the selection.

11. The apparatus as in claim 8, wherein the observed link cost metric comprises an expected transmission count (ETX) for the link.

12. The apparatus as in claim 11, wherein the statistics regarding the observed link cost metric used as a bootstrap by the Bayesian learning model comprise a mean and variance of the observed ETX for the link as conditional expectations.

13. The apparatus as in claim 8, wherein the observed node characteristics comprise at least one of: a transmission energy measurement for the node, an energy consumption rate for the node, or a remaining energy measurement for the node.

14. The apparatus as in claim 8, wherein the virtual link cost metric is not directly observable in the network.

15. A tangible, non-transitory, computer-readable medium storing program instructions that cause a processor of a device to execute a process comprising:
receiving, at the processor, observed node characteristics of a node in a network, wherein the node characteristics include a link cost metric for a network link associated with the node;
using, by the processor, a Bayesian learning model to estimate a virtual link cost metric based on the observed node characteristics, wherein the model uses statistics regarding the observed link cost metric as background belief measures; and
forming, by the processor, a routing path in the network that includes the network link in part based on an objective function that uses the virtual link cost metric as a parameter.

16. The computer-readable medium as in claim 15, wherein the observed node characteristics comprise one or more of: a link quality indicator (LQI) for the network link, a received signal strength indicator (RSSI) for the network link, a channel noise level, or a queue metric for the node.

17. The computer-readable medium as in claim 15, wherein the observed link cost metric comprises an expected transmission count (ETX) for the link.

18. The computer-readable medium as in claim 17, wherein the statistics regarding the observed link cost metric used as a bootstrap by the Bayesian learning model comprise a mean and variance of the observed ETX for the link as conditional expectations.

19. The computer-readable medium as in claim 15, wherein the observed node characteristics comprise at least one of: a transmission energy measurement for the node, an energy consumption rate for the node, or a remaining energy measurement for the node.

20. The computer-readable medium as in claim 15, wherein the virtual link cost metric is not directly observable in the network.
